(19) United States
(12) Patent Application Publication
(10) Pub. No.: US 2025/0050760 A1
(43) Pub. Date: Feb. 13, 2025

(54) AUTOMOTIVE INTEGRATED ON-BOARD CHARGER USING INVERTER AND MOTOR WINDINGS

(71) Applicant: FORD GLOBAL TECHNOLOGIES, LLC, DEARBORN, MI (US)

(72) Inventors: Petros G. Taskas, Novi, MI (US); Baoming Ge, Okemos, MI (US)

(21) Appl. No.: 18/448,473

(22) Filed: Aug. 11, 2023

(51) Int. Cl. B60L 53/24; B60L 53/22

(52) U.S. Cl. CPC B60L 53/24; B60L 53/22; B60L 50/60; B60L 2210/30; B60L 2210/40

(57) ABSTRACT

An automotive on-board charger topology includes an inverter, an electric machine, and a rectifier that together perform functions such as power factor correction usually performed by a collection of multiple components. This topology also includes a set of contactors that isolate a battery from other components of the charger based on the contactors' configuration.

### TECHNICAL FIELD

This disclosure relates to automotive power systems.

### BACKGROUND

An automotive vehicle may use electrical energy to power an electric machine. The electric machine may convert this electrical energy to mechanical energy to propel the vehicle. The automotive vehicle may include various power electronics equipment to condition and store the electrical energy. The automotive vehicle may include other components that receive electrical energy from a power grid.

### SUMMARY

An automotive on-board charger includes a battery, an inverter, a rectifier, an electric machine, including windings, connected between the inverter and rectifier, and a controller. The controller operates the inverter such that the inverter, windings, and rectifier together shift a phase between a voltage and current of power from a grid to alter a power factor of the power.

A method includes, responsive to receiving input power from an AC grid, operating a plurality of switches of an inverter such that the inverter, a rectifier, and windings of an electric machine, that is connected between the rectifier and inverter, together shift a phase between a voltage and current of the input power to alter a power factor of the input power.

A vehicle has a power system including a battery, an inverter, a rectifier, a transformer, an electric machine connected between the inverter and the rectifier, and a controller. The controller, during charge, operates the inverter to alter a power factor of power from a grid via the inverter, the rectifier, and windings of the electric machine, and after the charge, opens at least one contactor such that power output from the inverter for the battery passes through the transformer.

### BRIEF DESCRIPTION OF THE DRAWINGS

FIG. 1 is a schematic diagram of a typical AC charger.

FIG. 2 is a schematic diagram of an example integrated AC on-board charger.

FIG. 3 is a diagram of the power factor correction control of the integrated AC on-board charger of FIG. 2.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

AC on-board chargers typically include a separate enclosed system with many electrical components not including the traction inverter and motor. For example, a typical AC on-board charger can include at least the following components: seven diodes, eleven active switches, four inductors, two power capacitors, and one high-frequency transformer that includes a grid side and a battery side. Using these components, a typical charger could produce three-phased interleaved AC on-board charging from an AC grid. Other typical examples include more components than those mentioned above.

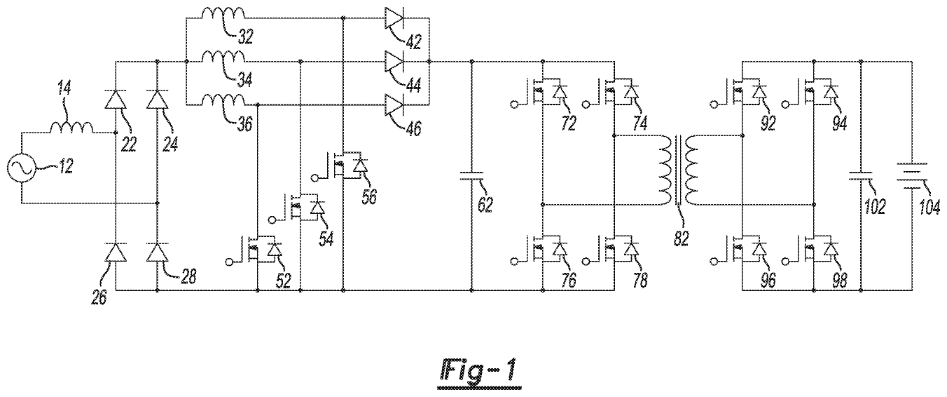

FIG. 1 is a schematic of a typical AC on-board charger. FIG. 1 shows an AC grid 12 in series with an inductor 14. The inductor connects to a diode 22 and to a diode 26. The AC grid 12 connects to a diode 24 and to a diode 28. The diode 22 connects to the diode 24, to the diode 26, and to the inductor 14. The diode 24 connects to the diode 22, to the diode 28, and to the AC grid 12. The diode 26 connects to the diode 22, to the diode 28, and to the inductor 14. The diode 28 connects to the diode 24, to the diode 26, and to the AC grid 12. The diode 24 and the diode 22 connect also to an inductor 32, to an inductor 34, and to an inductor 36. The diode 26 and the diode 28 connect also to a switch 52, to a switch 54, to a switch 56, to a capacitor 62, to a switch 76, and to a switch 78. The inductor 32 connects to the diode 22, to the diode 24, to the inductor 34, to the inductor 36, to a diode 42, and to the switch 56. The inductor 34 connects to the diode 22, to the diode 24, to the inductor 32, to the inductor 36, to a diode 44, and to the switch 54. The inductor 36 connects to the diode 22, to the diode 24, to the inductor 32, to the inductor 34, to a diode 46, and to the switch 52. The switch 52 connects the diode 26, the diode 28, the switch 54, the switch 56, the capacitor 62, the switch 76, and the switch 78 with the inductor 36 and with the diode 46. The switch 54 connects the diode 26, the diode 28, the switch 52, the switch 56, the capacitor 62, the switch 76, and the switch 78 with the inductor 34 and with the diode 44. The switch 56 connects the diode 26, the diode 28, the switch 52, the switch 54, the capacitor 62, the switch 76, and the switch 78 with the inductor 32 and with the diode 42. The diode 42, the diode 44, and the diode 46 are connected to components as described, to each other, to a capacitor 62, to a switch 72, and to a switch 74. The capacitor 62 connects the diode 42, the diode 44, the diode 46, the switch 72, and the switch 74 with the diode 26, with the diode 28, with the switch 52, with the switch 54, with the switch 56, with the switch 76, and with the switch 76. The switch 72 is connected to components as described, to the switch 76, to the switch 74, and to a high-frequency transformer's coils 82. The switch 76 is connected to components described above, to the switch 72, to the switch 78, and to a high-frequency transformer's coils 82. The switch 74 is connected to components described above, to the switch 78, to the switch 72, and to a high-frequency transformer's coils 82. The switch 78 is connected to components described above, to the switch 74, to the switch 76, and to a high-frequency transformer's coils 82. The high-frequency transformer's coils 82 connect between the switch 72 and the switch 76 on a first node of a grid-side of the coils 82. The coils 82 connect between the switch 74 and the switch 78 on a second node of the grid-side. The coils 82 connect between a switch 92 and a switch 96 on a first node of a battery-side of the coils 82. The coils 82 connect between a switch 94 and a switch 98 on a second node of the battery-side. The switch 92 is connected to components described above, to the switch 94, to the switch 96, to a capacitor 102, and to a voltage supply 104. The switch 96 is connected to components described above, to the switch 98, to the capacitor 102, and to the voltage supply 104. The switch 94 is connected to components described above, to the switch 98, to the capacitor 102, and to the voltage supply 104. The switch 98 is connected to components described above, to the capacitor 102, and to the voltage supply 104. The capacitor 102 and the battery 104 are in parallel.

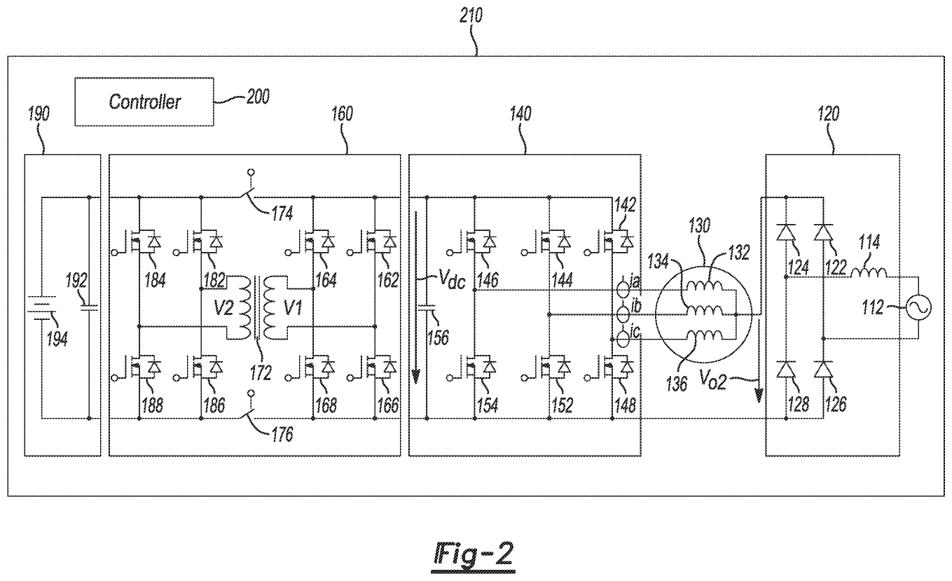

FIG. 2 is a schematic of the electronic components within an automotive on-board charger. The schematic shows the charger's topology which may include a rectifier 120, an electric machine 130, an inverter system controller (“ISC”) 140, a transformer 160, a battery 190, and a controller 200. The controller 200 is in communication with/exerts control over the rectifier 120, electric machine 130, ISC 140, transformer 160, and battery 190, which are collectively shown within the context of a vehicle 210. The charger is designed to connect to an AC grid 112.

The rectifier 120 may include an inductor 114 in series with the AC grid 112 and four diodes 122, 124, 126, 128. The diode 122 connects to the diode 124, to the diode 126, and to the AC grid 112. The diode 124 connects to the diode 122, to the diode 128, and to the inductor 114. The diode 126 connects to the diode 122, to the diode 128, and to the AC grid 112. The diode 128 connects to the diode 124, to the diode 126, and to the inductor 114. The diode 128 and the diode 126 connect to the ISC 140. The diode 124 and the diode 122 connect to the electric machine 130. The rectifier 120 thus connects both between the AC grid 112 and the electric machine 130 and between the AC grid 112 and the ISC 140.

The electric machine 130 may include three coils 132, 134, 136 together called “windings.” The coil 132 connects to the coil 134, to the coil 136 and to the rectifier 120 by connecting to the diode 124 and to the diode 122. The coil 134 connects to the coil 132, to the coil 136 and to the rectifier 120 by connecting to the diode 124 and to the diode 122. The coil 136 connects to the coil 132, to the coil 134 and to the rectifier 120 by connecting to the diode 124 and to the diode 122. The coil 132 connects to the ISC 140 by connecting to a switch 146 and to a switch 154. The coil 134 connects to the ISC 140 by connecting to a switch 144 and to a switch 152. The coil 136 connects to the ISC 140 by connecting to a switch 142 and to a switch 148.

The ISC 140 may include six switches 142, 144, 146, 148, 152, 154, and a capacitor 156. Within the ISC 140, the switch 142 connects the switch 148 and the inductor 136 with the switch 144, with the switch 146, and with the capacitor 156. Within the ISC 140, the switch 144 connects the switch 152 and the inductor 134 with the switch 142, with the switch 146, and with the capacitor 156. Within the ISC 140, the switch 146 connects the switch 154 and the inductor 132 with the switch 142, with the switch 144, and with the capacitor 156. Within the ISC 140, the switch 148 connects the switch 142 and the inductor 136, to the switch 152, to the switch 154, and to the capacitor 156. Within the ISC 140, the switch 152 connects the switch 144 and the inductor 134 with the switch 148, with the switch 154, and with the capacitor 156. Within the ISC 140, the switch 154 connects the switch 146 and the inductor 132 with the switch 148, with the switch 152, and with the capacitor 156. Within the ISC 140, the capacitor 156 connects the switch 142, the switch 144, and the switch 146 with the switch 148, with the switch 152, and with the switch 154.

The ISC 140 connects to the rectifier 120 by the switch 148, the switch 152, the switch 154, and the capacitor 156 within the ISC 140 connecting to the diode 128 and the diode 126 within the rectifier 120. The ISC 140 connects to the transformer 160 by the switch 148, the switch 152, the switch 154, and the capacitor 156 within the ISC 140 connecting to a switch 166, to a switch 168, and to a contactor 176 within the transformer 160. The ISC 140 also connects to the transformer 160 by the switch 142, the switch 144, the switch 146, and the capacitor 156 within the ISC 140 connecting to a switch 162, to a switch 164, and to a contactor 174 within the transformer 160.

The transformer 160 may include eight switches 162, 164, 166, 168, 182, 184, 186, 188, two contactors 174, 176, and coils 172. Within the transformer 160, the switch 162 connects the switch 166 and the coils 172 with the switch 164 and with the contactor 174. Within the transformer 160, the switch 164 connects the switch 168 and the coils 172 with the switch 162 and with the contactor 174. Within the transformer 160, the switch 166 connects the switch 162 and the coils 172 with the switch 168 and with the contactor 176. Within the transformer 160, the switch 168 connects the switch 164 and the coils 172 with the switch 166 and with the contactor 176. Within the transformer 160, the switch 182 connects the switch 186 and the coils 172 with the switch 184 and with the contactor 174. Within the transformer 160, the switch 184 connects the switch 188 and the coils 172 with the switch 182 and with the contactor 174. Within the transformer 160, the switch 186 connects the switch 182 and the coils 172 with the switch 188 and with the contactor 176. Within the transformer 160, the switch 188 connects the switch 184 and the coils 172 with the switch 186 and with the contactor 176. The coils 172 connect the switch 162 and the switch 166 with the switch 164 and with the switch 168 on a grid-side of the coils 172. The coils 172 connect the switch 182 and the switch 186 with the switch 184 and with the switch 188 on a battery-side of the coils 172.

The contactor 174 can connect the switch 162 and the switch 164 with the switch 182 and the switch 184 when the contactor 174 assumes a predefined state, such as “closed.” The contactor 176 can connect the switch 166 and the switch 168 with the switch 186 and the switch 188 when the contactor 176 assumes a predefined state, such as “closed.” In another predefined state, such as “open,” the contactor 174 disconnects the switch 162 and the switch 164 from the switch 182 and from the switch 184. In another predefined state, such as “open,” the contactor 176 disconnects the switch 166 and the switch 168 from the switch 186 and from the switch 188.

The transformer 160 connects to the ISC 140 and to the battery 190. The switch 162, the switch 164, and the contactor 174 within the transformer 160 connect to the ISC 140 by connecting to the capacitor 156, to the switch 146, to the switch 144, and to the switch 142 within the ISC 140. The switch 166, the switch 168, and the contactor 176 within the transformer 160 connect to the ISC 140 by connecting to the capacitor 156, to the switch 154, to the switch 152, and to the switch 148 within the ISC 140.

The battery 190 contains a capacitor 192 and a voltage supply 194 arranged in parallel. In other arrangements, the capacitor 192 is not part of the battery 190. The battery 190 connects to the transformer 160. The voltage supply 194 and the capacitor 192 within the battery 190 connect the switch 184, the switch 182, and the contactor 174 within the transformer 160 with the switch 188, the switch 186, and the contactor 176 within the transformer 160.

When the contactor 174 and the contactor 176 are both closed, power from the battery 190 can bypass the coils 172 of the transformer 160 and be delivered to the electric machine 130 via the ISC 140. Similarly, when the contactor 174 and the contactor 176 are both closed, power from the electric machine 130 through the ISC 140 can bypass the coils 172 of the transformer 160 and be delivered directly to the battery 190. When the contactor 174 and the contactor 176 are both open, power from the AC grid 112 after passing through the rectifier 120, electric machine 130, and ISC 140, passes through the coils 172 of the transformer 160 to charge the battery 190.

The components operate under the command of the controller 200 such that when the vehicle 210 is not being charged by the on-board charger, the contactors 174, 176 are closed to cause power from the battery 190 to bypass the coils 172 of the transformer 160 to connect directly to the ISC 140. When the vehicle 210 is being charged by the on-board charger, the contactors 174, 176 are open to cause the transformer 160 to galvanically isolate the battery 190 and boost the input voltage for charging the battery 190.

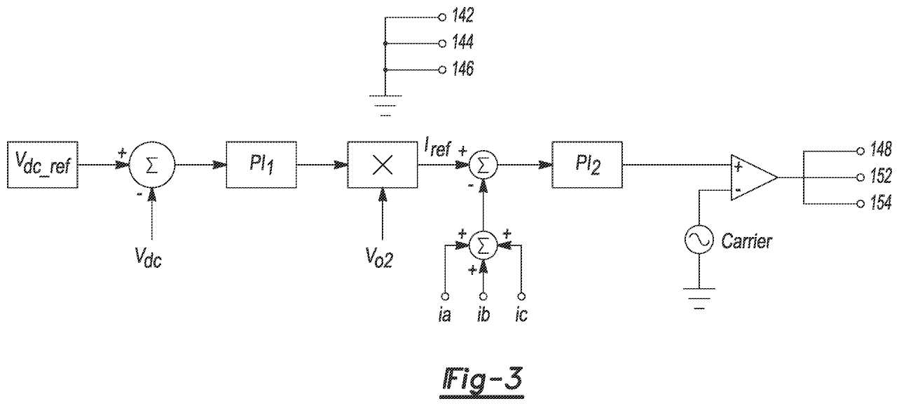

FIG. 3 is a diagram of the power factor correction (“PFC”) control of the integrated AC on-board charger, which may be implemented by the controller 200. Some the variables described in FIG. 3, such as Vo2, Vdc, ia, ib, ic, V1, and V2 can be seen in FIG. 2. The current reference Iref is the product of the neutral point voltage Vo2 and the output of a proportional and integral (“PI”) controller PI1. The current reference Iref relates to battery charging current. The amplitude of the current reference Iref is from a voltage closed loop controller. The DC bus voltage Vdc is compared with the reference voltage Vdc_ref. Their error is input to the controller PI1 to adjust the amplitude of current reference Iref.

The ISC 140 has three current sensors that are used for the motor current-closed-loop control in the vehicle operation mode. In the AC on-board charging mode, the three current sensors feedback currents ia, ib, ic are used to achieve current closed-loop control for the PFC control through PI2 as shown in FIG. 3. The output of the controller PI2 compares a triangular carrier to generate switching signals to control the switches 148, 152, and 154 to boost voltage for charging the traction battery 190 while achieving unity power factor. The switches 142, 144, and 146 are turned off during charging.

The controller 200 may be programmed to operate the transformer 160 by controlling the opening and closing of the switch 162, the switch 164, the switch 166, the switch 168, the switch 182, the switch 184, the switch 186, and the switch 188. A program may differ depending on a current mode of the vehicle 210.

For example, when the vehicle 210 is in a driving mode, the contactor 174 and the contactor 176 are closed and the switch 162, the switch 164, the switch 166, the switch 168, the switch 182, the switch 184, the switch 186, and the switch 188 are deactivated.

When the vehicle 210 is in a charging mode, the contactors 174 and 176 are open and the switch 162, the switch 164, the switch 166, the switch 168, the switch 182, the switch 184, the switch 186, and the switch 188 follow a predetermined pattern. The predetermined pattern may include operating V1 and V2 with two voltage levels in FIG. 2 and a 0.5 duty cycle and using the phase angle difference between V1 and V2 to control power transfer.

V1 may be generated by controlling the switch 162, the switch 164, the switch 166, and the switch 168. Generating V1 may include a first switching state created by turning the switch 164 and the switch 166 to a first of the voltage levels (“on”) and turning the switch 162 and the switch 168 to a second of the voltage levels (“off”). While in the first switching state, V1=Vdc. Generating V1 may also include a second switching state created by turning the switch 162 and the switch 168 on and turning the switch 164 and the switch 166 off. While in the second switching state, V1=−Vdc. To achieve a 0.5 duty cycle, the time spent in the first switching state equals the time spent in the second switching state. To achieve a desired switching frequency fsw, each of the first switching state and the second switching state are present for a time t=0.5/fsw.

V2 may be generated by controlling the switch 182, the switch 184, the switch 186, and the switch 188. Generating V2 may include a first switching state created by turning the switch 184 and the switch 186 on and turning the switch 182 and the switch 188 off. While in the first switching state, V2=Vdc. Generating V2 may also include a second switching state created by turning the switch 182 and the switch 188 on and turning the switch 184 and the switch 186 off. While in the second switching state, V2=−Vdc.

The controller may adjust the phase angle of V2 to modify the amount of power transferred from the AC grid to the traction battery. The control may include a phase angle closed-loop control.

The typical charger of FIG. 1 includes components that are removed in the AC on-board charger of FIG. 2. Specifically, the AC on-board charger here removes the three diodes 42, 44, 46, the three inductors 32, 34, 36, and the three switches, 52, 54, 56 from FIG. 1, while retaining functionality by the windings 132, 134, 136 of the electric machine 130, the inverter 140, and the rectifier 120. While charging, the windings 132, 134, 136 of the electric machine 130, the inverter 140, and the rectifier 120 together provide power factor correction. The components added to achieve the example system of FIG. 2 include the two contactors 174, 176. The AC on-board charger reduces the ISC's bus capacitance by having the two capacitors 156, 192 in parallel when the contactors 174, 176 are closed.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. Other topologies and variations are, of course, contemplated.

The words used in the specification are words of description rather than limitation, and it is understood that various changes may be made without departing from the spirit and scope of these disclosed materials. The terms “controller” and “controllers,” for example, can be used interchangeably herein as the functionality of a controller can be distributed across several controllers/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An automotive on-board charger comprising:
a battery;
an inverter;
a rectifier;
an electric machine, including windings, connected between the inverter and rectifier; and
a controller programmed to operate the inverter such that the inverter, windings, and rectifier together shift a phase between a voltage and current of power from a grid to alter a power factor of the power.

2. The automotive on-board charger of claim 1 further comprising a transformer, including at least one contactor, connected between the battery and inverter.

3. The automotive on-board charger of claim 2, wherein the transformer is configured such that when the at least one contactor is in a predefined state, the battery and inverter are connected.

4. The automotive on-board charger of claim 2, wherein the transformer further includes a plurality of switches and wherein the controller is programmed to operate the switches in a predefined pattern to alter the voltage to charge the battery.

5. The automotive on-board charger of claim 1, wherein the inverter includes a plurality of switches and wherein the controller is further programmed to operate the switches such that the inverter transforms DC power from the battery to AC power for the electric machine.

6. The automotive on-board charger of claim 1, wherein the inverter is configured to transform AC power from the electric machine to DC power for the battery.

7. The automotive on-board charger of claim 1, wherein the inverter is an n-phase inverter.

8. The automotive on-board charger of claim 1, wherein the rectifier is a diode rectifier.

9. The automotive on-board charger of claim 1, wherein the rectifier is an n-phase rectifier.

10. The automotive on-board charger of claim 1, wherein the electric machine is a motor.

11. A method comprising:
responsive to receiving input power from an AC grid, operating a plurality of switches of an inverter such that the inverter, a rectifier, and windings of an electric machine, that is connected between the rectifier and inverter, together shift a phase between a voltage and current of the input power to alter a power factor of the input power.

12. The method of claim 11 further comprising, while connected to the AC grid, opening at least one contactor such that a power output from the inverter passes through a transformer prior to delivery to a battery.

13. The method of claim 11 further comprising while disconnected from the AC grid, closing at least one contactor to connect a battery to the electric machine.

14. A vehicle comprising:
a power system including a battery, an inverter, a rectifier, a transformer, an electric machine connected between the inverter and the rectifier, and a controller programmed to
during charge, operate the inverter to alter a power factor of power from a grid via the inverter, the rectifier, and windings of the electric machine, and
after the charge, close at least one contactor such that power between the battery and the inverter bypass the transformer.

15. The vehicle of claim 14, wherein the controller is further programmed to, when preparing to charge, open the at least one contactor such that a power from the grid will pass through the transformer.

16. The vehicle of claim 14, wherein the transformer further includes a plurality of switches and wherein the controller is further programmed to operate the switches in a predefined pattern to alter a voltage delivered to the battery during the charge.

17. The vehicle of claim 14, wherein the inverter includes a plurality of switches and wherein the controller is further programmed to operate the switches such that the inverter transforms DC power from the battery to AC power for the electric machine.

18. The vehicle of claim 14, wherein the inverter is an n-phase inverter.

19. The vehicle of claim 14, wherein the electric machine is a motor.

20. The vehicle of claim 14, wherein the rectifier is an n-phase rectifier.
